(19) United States
(12) Patent Application Publication
(10) Pub. No.: US 2026/0015902 A1
(43) Pub. Date: Jan. 15, 2026

(54) Automated Window Device

(71) Applicant: Steven Holt, Mantua, OH (US)

(72) Inventor: Steven Holt, Mantua, OH (US)

(21) Appl. No.: 19/033,729

(22) Filed: Jan. 22, 2025

Related U.S. Application Data
(60) Provisional application No. 63/668,970, filed on Jul. 9, 2024.

(51) Int. Cl. E05F 15/77; E05B 47/00; E05F 15/603

(52) U.S. Cl. CPC E05F 15/77; E05F 15/71; E05Y 2900/148

(57) ABSTRACT

An automated window device is provided. The device is comprised of a motorized window device comprising at least one window, which may include styles such as sliding, casement, awning, hopper, or fixed, and can alternatively be substituted with sliding doors. Each window is powered by an electric motor configured for specific window motions, such as linear actuators for sliding windows or rotary actuators for casement windows, ensuring smooth and efficient operation. The motor integrates a microcontroller enabling wireless control via a mobile application, which facilitates remote operation, position monitoring, and scheduling for automated adjustments. Additionally, motorized locks, also controlled through the application, enhance security by allowing remote locking and status monitoring.

### CROSS-REFERENCE TO RELATED APPLICATION

The present application claims priority to, and the benefit of, U.S. Provisional Application No. 63/668,970, which was filed on Jul. 9, 2024, and is incorporated herein by reference in its entirety.

### FIELD OF THE INVENTION

The present invention relates generally to the field of windows. More specifically, the present invention relates to a window powered by electric motors with integrated microcontrollers, enabling wireless control via a mobile application for remote operation, position monitoring, scheduling, and enhanced security through motorized locks. Integration with weather services also allows automated adjustments based on environmental conditions, combining weather- and time-based automation for convenience and energy efficiency. Accordingly, the present disclosure makes specific reference thereto. Nonetheless, it is to be appreciated that aspects of the present invention are also equally applicable to other like applications, devices, and methods of manufacture.

### BACKGROUND

Home security and convenience have become increasingly dependent on automation technologies, particularly as busy lifestyles and frequent travel often lead to last-minute oversight of critical tasks. Securing windows, a primary access point, remains an area of concern that is largely unaddressed by current home automation systems. When leaving the home, whether for daily errands or extended vacations, homeowners face the challenge of ensuring that all windows are closed and locked. This task, while simple, can be overlooked amidst other priorities, especially during rushed departures involving family members, luggage, or tight schedules. When such oversights occur, homeowners may be left to either double back to verify window security or rely on friends, family, or neighbors to check these access points.

Existing smart home solutions provide automated control over a variety of household systems, including lighting, door locks, garage doors, and window blinds, enhancing both security and convenience. However, home windows, which are crucial for both security and environmental control, remain largely manual. Windows are often only secured through physical latches, requiring direct action to open, close, or lock, which limits homeowners' ability to ensure home security remotely. Additionally, weather events, such as sudden rainstorms or temperature drops, can pose risks if windows are accidentally left open, potentially leading to property damage or decreased energy efficiency. While other household systems are increasingly integrated with remote monitoring and automation features, windows remain a critical gap in comprehensive home management.

Therefore, there exists a long-felt need in the art for an automated window device that enables remote control of window opening and closing functions. There also exists a long-felt need in the art for an automated window device that provides a locking mechanism to secure windows against unauthorized access. Moreover, there exists a long-felt need in the art for an automated window device that integrates with existing home automation systems to provide a comprehensive and unified approach to home security and environmental control.

The subject matter disclosed and claimed herein, in one embodiment thereof, comprises an automated window device. The device is comprised of a motorized window device comprising at least one window, which may include styles such as sliding, casement, awning, hopper, or fixed, and can alternatively be substituted with sliding doors. Each window is powered by an electric motor configured for specific window motions, such as linear actuators for sliding windows or rotary actuators for casement windows, ensuring smooth and efficient operation. The motor integrates a microcontroller enabling wireless control via a mobile application, which facilitates remote operation, position monitoring, and scheduling for automated adjustments. Additionally, motorized locks, also controlled through the application, enhance security by allowing remote locking and status monitoring. Advanced integration with weather services enables automated responses to environmental changes, such as closing windows during rain or opening them in optimal temperatures, combining weather- and time-based automation for user convenience and energy efficiency.

In this manner, the automated window device of the present invention accomplishes all the forgoing objectives and provides a fully motorized window frame, enabling users to automate and remotely control the opening, closing, and locking of windows. By incorporating Wi-Fi and Bluetooth connectivity, the device seamlessly integrates with home automation platforms, allowing users to monitor and manage their Windows status from a smartphone or compatible device. This system enhances home security by ensuring windows can be reliably secured without requiring manual intervention. Consequently, the automated window device fulfills critical needs in home security and automation, closing the existing gap in remote home management solutions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated window device. The device is comprised of at least one window, which can be configured in various styles, including sliding, casement, awning, hopper, and fixed windows. The design and functionality are adaptable to accommodate the characteristics of these styles, with the window optionally substitutable with a sliding door or similar door in certain embodiments.

The window is further comprised of an electric motor that functions as the primary mechanism for opening and closing. The motor is powered by a hardwired connection to a building's electrical system, ensuring consistent operation. The motor type is tailored to the specific window style: linear actuators for sliding windows, rotary actuators for casement and awning windows, and gear-driven motors for hopper windows. Each configuration is optimized for smooth, efficient operation.

The motor incorporates a microcontroller providing wireless communication via Wi-Fi or Bluetooth. The microcontroller connects to a mobile application, enabling remote control and monitoring of the window. Key functionalities include remote opening and closing with position adjustment, status checking of the window's open or closed state, and a scheduling feature for automated operation based on user-defined times or dates. The application may integrate with existing home automation systems.

In some embodiments, the window is equipped with a motorized lock, which is also wirelessly controllable via the application. Users can remotely lock or unlock the window and check the lock's status. Various lock types, such as solenoid locks and motor-driven deadbolts, are supported to suit different window styles, enhancing security and control.

The mobile application may integrate with weather services, enabling automated operation based on environmental conditions. Users can set parameters such as temperature, humidity, wind speed, or precipitation to trigger the automatic opening or closing of the window. For example, the window can close when rain is detected or open when the temperature falls within a comfortable range. This feature improves indoor comfort and efficiency while enhancing usability.

The integration with weather services complements the scheduling feature, allowing users to combine time-based and weather-based automation for greater adaptability to varying environmental conditions. This ensures comprehensive and convenient control of the window's operation.

Accordingly, the automated window device of the present invention is particularly advantageous as it provides a fully motorized window frame, enabling users to automate and remotely control the opening, closing, and locking of windows. By incorporating Wi-Fi and Bluetooth connectivity, the device seamlessly integrates with home automation platforms, allowing users to monitor and manage their windows status from a smartphone or compatible device. This system enhances home security by ensuring windows can be reliably secured without requiring manual intervention. Consequently, the automated window device fulfills critical needs in home security and automation, closing the existing gap in remote home management solutions. In this manner, the automated window device overcomes the limitations of existing windows known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an automated window device of the present invention in an open state in accordance with the disclosed architecture; and

FIG. 2 illustrates a graphical view of a mobile application of one potential embodiment of an automated window device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an automated window device that enables remote control of window opening and closing functions. There also exists a long-felt need in the art for an automated window device that provides a locking mechanism to secure windows against unauthorized access. Moreover, there exists a long-felt need in the art for an automated window device that integrates with existing home automation systems to provide a comprehensive and unified approach to home security and environmental control.

The present invention, in one exemplary embodiment, is comprised of an automated window device. The device comprises at least one window that can be configured in various styles, including double hung, single hung, double and triple sliding, casement, awning, and hopper windows. The design and functionality are adaptable to accommodate the characteristics of these styles, with the window optionally replaceable with a sliding door or similar door in certain embodiments.

The window includes either a singular or two electric motor(s), depending on the window style as the primary mechanism for opening and closing, powered by a low voltage hardwired connection to a building's electrical system for consistent operation. The motor type is customized to the specific window style, such as linear actuators for sliding windows, rotary actuators for casement and awning windows, and gear-driven motors for hopper windows, ensuring smooth and efficient operation.

The motor incorporates a microcontroller with wireless communication capabilities via Wi-Fi or Bluetooth. The microcontroller connects to a mobile application, enabling remote control and monitoring of the window. Key features include remote opening and closing with position adjustment, status checking of the window's open or closed state, and a scheduling function for automated operation at user-defined times or dates. The application may also integrate with existing home automation systems.

In some embodiments, the window features a motorized lock that can be wirelessly controlled through the application. Users can lock or unlock the window remotely and check the lock's status. Various lock types, such as solenoid locks and motor-driven deadbolts, are supported to suit different window styles, providing enhanced security and control.

The mobile application integrates with weather services to enable automated operation based on environmental conditions. Users can set parameters such as temperature, humidity, wind speed, or precipitation to trigger automatic window opening or closing. For instance, the window can close when rain is detected or open when the temperature is within a comfortable range, improving indoor comfort and efficiency.

This weather service integration complements the scheduling feature, allowing users to combine time-based and weather-based automation for greater adaptability to changing environmental conditions. This ensures comprehensive and convenient control of the window's operation.

The automated window device offers a fully motorized window frame, enabling users to automate and remotely control the opening, closing, and locking of windows. With Wi-Fi and Bluetooth connectivity, the device integrates seamlessly with home automation platforms, and security systems allowing users to monitor and manage their windows from a smartphone or compatible device, as well as central monitoring with compatible alarm systems to know when the window is closed and locked while the alarm is set. This system enhances home security by ensuring windows can be securely locked without manual intervention. The device addresses critical needs in home security and automation, filling a gap in remote home management solutions and overcoming the limitations of existing windows.

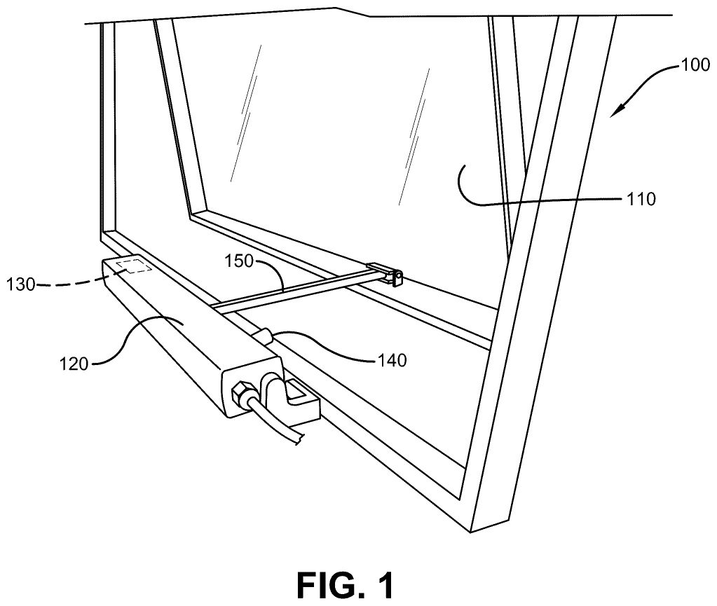

Referring initially to the drawings, FIG. 1 illustrates a perspective view of one potential embodiment of an automated window device 100 of the present invention in an open state in accordance with the disclosed architecture. The device 100 is comprised of at least one window 110. It should be appreciated that the window 110 may be any style of window in different embodiments such as but not limited to sliding windows, casement windows, awning windows, hopper windows, and fixed windows. Further, the specific design and functionality of the device 100 are tailored to accommodate the unique characteristics of each window style. In one embodiment, the window 110 may be substituted with a sliding door or other similar door.

The window 110 is further comprised of at least one electric motor 120, which serves as the primary mechanism for opening and closing the window 110. The motor 120 is powered via a hardwired connection integrated into a structure's (i.e., a home's) electrical system, ensuring consistent and reliable power delivery. The motor 120 is adaptable to the requirements of different window styles. For example, linear actuator motors 120 may be utilized for sliding windows to facilitate linear motion, rotary actuator motors 120 may be implemented for casement and awning windows to enable rotational movement, and compact gear-driven motors 120 may be employed for hopper windows to manage the tilt or swing motion. Each motor 120 configuration is optimized to meet the specific motion and force requirements of the corresponding window style, ensuring smooth, efficient, and reliable operation. It should be appreciated that the motor 120 contacts a portion of the window 110 during use via any type of structure/connection member 150, as seen in FIG. 1.

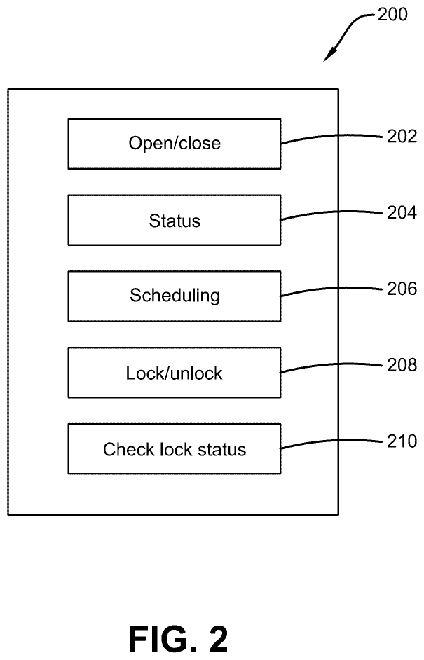

Each motor 120 is comprised of at least one microcontroller 130, which provides wireless communication capabilities via Wi-Fi or Bluetooth. The microcontroller 130 is in wireless electrical communication with at least one mobile application 200, enabling remote control and monitoring of the window 110. As shown graphically in FIG. 2, the application 200 offers several functionalities that enhance the user experience. First, the application 200 allows a user to open and close 202 the window 110 remotely. This feature 202 enables both full and partial adjustments to the window's 110 position, providing enhanced convenience and flexibility. Next, the application 200 allows a user to check the status 204 of the window 110. More specifically, the motor 120 communicates with the application 200 to indicate whether the window 110 is currently in an open or closed position by relaying information about the motor's 120 extended or retracted state. Additionally, the application 200 is comprised of a scheduling feature 206, which allows the user to schedule the opening and closing of the window 110 at specific times, on certain days, or within defined dates and/or time ranges. This functionality adds automation and customization to the device's 100 operation. In one embodiment, the application 200 may be an existing home automation application, software, system, etc.

In some embodiments, the window 110 is further comprised of at least one motorized lock 140. The lock 140 is in wireless communication with the application 200 via Wi-Fi or Bluetooth, allowing the user to lock or unlock 208 the window 110 remotely via the application 200. The application 200 also enables the user to check the status of the lock 140, indicating whether it is currently locked or unlocked. This feature provides an added layer of security and control. The motorized lock 140 may be implemented in various configurations to suit the requirements of different window styles. Examples of such locks 140 include but are not limited to solenoid locks, motor-driven deadbolts, a latch actuator lock, etc.

In one embodiment, the mobile application 200 is configured to integrate with a weather service application or information source, enabling advanced automation based on environmental conditions. Through this integration, the application 200 can automatically open and/or close the window 110 in response to weather changes, offering enhanced functionality and convenience. Users can customize weather parameters within the application 200, such as temperature thresholds, humidity levels, wind speeds, or precipitation forecasts, to dictate the automatic operation of the window 110.

For example, the user may set the application 200 to close the window 110 automatically if rain is detected or if the wind speed exceeds a specified limit. Similarly, the application 200 may be configured to open the window 110 when the temperature falls within a user-defined comfort range. This feature not only improves the usability of the device 100 but also helps maintain indoor comfort and efficiency by responding dynamically to changing weather conditions.

The integration with a weather service application also complements the scheduling feature 206, allowing users to combine time-based and weather-based automation for more comprehensive control over the window 110's operation. This functionality ensures that the device 100 provides both convenience and adaptability to varying environmental conditions.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated window device” and “device” are interchangeable and refer to the automated window device 100 of the present invention.

Notwithstanding the forgoing, the automated window device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the automated window device 100 as shown in the FIGS. are for illustrative purposes only, and that many other sizes and shapes of the automated window device 100 are well within the scope of the present disclosure. Although the dimensions of the automated window device 100 are important design parameters for user convenience, the automated window device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automated window device comprising:
a window;
a motor coupled to the window, wherein the motor is configured to facilitate the opening and closing of the window;
a microcontroller operatively connected to the motor, the microcontroller being configured to enable a wireless communication; and
a mobile application in wireless communication with the microcontroller, the mobile application being configured to allow a user to remotely open and close the window, monitor a status of the window, and schedule an automated operation of the window.

2. The automated window device of claim 1, wherein the window is comprised of a sliding window, a casement window, an awning window, a hopper window, or a fixed window.

3. The automated window device of claim 1, wherein the motor is comprised of a linear actuator motor, rotary actuator motor, or compact gear-driven motor.

4. The automated window device of claim 1, wherein the wireless communication is comprised of a Wi-Fi connection.

5. The automated window device of claim 1, wherein the wireless communication is comprised of a Bluetooth connection.

6. The automated window device of claim 1, wherein the motor communicates a current state of the window to the mobile application based on an extended state or a retracted state of the motor.

7. The automated window device of claim 1, wherein the mobile application is comprised of a scheduling feature that allows for automated operation of the window at a specific time, a specific day, or a specific date range.

8. An automated window device comprising:
a window;
a motorized lock coupled to the window;
a motor coupled to the window, wherein the motor is configured to facilitate the opening and closing of the window;
a microcontroller operatively connected to the motor, the microcontroller being configured to enable a wireless communication; and
a mobile application in wireless communication with the microcontroller, the mobile application being configured to allow a user to remotely open and close the window, monitor a status of the window, and schedule an automated operation of the window.

9. The automated window device of claim 8, wherein the motorized lock is comprised of a solenoid lock, a motor-driven deadbolt, or a latch actuator lock.

10. The automated window device of claim 8, wherein the mobile application provides a real-time status update indicating whether the motorized lock is in a locked state or an unlocked state.

11. The automated window device of claim 8, wherein the window is comprised of a sliding window, a casement window, an awning window, a hopper window, or a fixed window.

12. The automated window device of claim 8, wherein the motor is comprised of a linear actuator motor, rotary actuator motor, or compact gear-driven motor.

13. The automated window device of claim 8, wherein the wireless communication is comprised of a Wi-Fi connection.

14. The automated window device of claim 8, wherein the wireless communication is comprised of a Bluetooth connection.

15. The automated window device of claim 8, wherein the motor communicates a current state of the window to the mobile application based on an extended state or a retracted state of the motor.

16. The automated window device of claim 8, wherein the mobile application is comprised of a scheduling feature that allows for automated operation of the window at a specific time, a specific day, or a specific date range.

17. An automated window device comprising:
a window;
a motorized lock coupled to the window;
a motor coupled to the window, wherein the motor is configured to facilitate the opening and closing of the window;
a microcontroller operatively connected to the motor, the microcontroller being configured to enable a wireless communication; and
a mobile application in wireless communication with the microcontroller, the mobile application being configured to allow a user to remotely open and close the window, monitor a status of the window, and schedule an automated operation of the window based on an environmental parameter.

18. The automated window device of claim 17, wherein the motorized lock is comprised of a solenoid lock, a motor-driven deadbolt, or a latch actuator lock.

19. The automated window device of claim 17, wherein the mobile application provides a real-time status update indicating whether the motorized lock is in a locked state or an unlocked state.

20. The automated window device of claim 17, wherein the motorized lock is comprised of a solenoid lock, a motor-driven deadbolt, or a latch actuator lock.
